(19) United States
(12) Patent Application Publication
(10) Pub. No.: US 2024/0240041 A1
(43) Pub. Date: Jul. 18, 2024

(54) RADIATION-CURABLE COMPOSITION TO PRODUCE SUPPORT SUB-STRUCTURE FOR 3D PHOTOPOLYMER JETTING

(71) Applicant: BASF SE, Ludwigshafen am Rhein (DE)

(72) Inventors: Fan ZHANG, Shanghai (CN); Jie LU, Shanghai (CN); Chong Xi WANG, Shanghai (CN); Zhi Zhong CAI, Shanghai (CN)

(21) Appl. No.: 18/558,420

(22) PCT Filed: Apr. 29, 2022
(86) PCT No.: PCT/EP2022/061536

§ 371 Date: Nov. 1, 2023

(30) Foreign Application Priority Data
May 7, 2021 (WO) PCT/CN2021/092113

(51) Int. Cl. C09D 11/38; B29C 64/112; B29C 64/124; B29C 64/40; B33Y 10/00; B33Y 70/10; B33Y 80/00

(52) U.S. Cl. CPC C09D 11/38; B29C 64/112; B29C 64/124; B29C 64/40; B33Y 10/00; B33Y 70/10; B33Y 80/00

(57) ABSTRACT

This disclosure relates to a radiation-curable composition comprising (A) at least one water-soluble monofunctional ethylenically unsaturated monomer; (B) at least one water-soluble non-curable component, wherein the weighted average melting point of component (B) is more than 22° C. preferably more than 25° C.; and (C) at least one photoinitiator.

### TECHNOLOGY FIELD

The present invention is directed to a radiation-curable composition capable of producing a 3D-printed support sub-structure for photopolymer jetting, and to a 3D-printing process using said radiation-curable composition, and to a 3D-printed article obtainable with said 3D-printing process.

### BACKGROUND

Photopolymer jetting (PPJ) 3D printing is a high resolution Additive Manufacturing (AM) method which produces structures by stacking up material droplets. Benefiting from the capability to include multiple drop-on-demand inkjet printheads in a single machine, PPJ allows co-printing of multiple functional materials in picolitre droplets by selectively depositing them to the target location to form either 2D or 3D structures. Owing to the multi-material printing function, a support material can be printed together with build materials to form complex geometries such as interlocks, overhangs and hollow structures and can be removed after printing. The printed build material and the support material form a composite structure with a 3D-printed support sub-structure formed by the support material and a 3D-printed build sub-structure formed by the build material, wherein the 3D-printed support sub-structure supports the 3D-printed build sub-structure. After the completion of the process, the 3D-printed support sub-structure is removed, leaving the 3D-printed article made of the 3D-printed build sub-structure as the final product.

U.S. Pat. No. 6,569,373 discloses a composition suitable for use as a support material for three-dimensional objects, wherein, after curing, said composition results in a solid form capable of swelling or breaking down upon exposure to water or to an alkaline or acidic water solution.

U.S. Pat. No. 9,334,402 discloses a composition suitable for support in building a 3D object, wherein after irradiation, the composition results in a solid, a semi solid or a gel material which are partially soluble in water or capable of swelling in water, alkaline, acidic water or water detergent solution.

U.S. Pat. No. 8,460,451 discloses a support material for use in a three-dimensional printing system comprising a wax component which is water soluble but a not a UV curable resin and requires a special printhead with heating function to print.

The removal of the 3D-printed support sub-structure is normally done by chemical washing process using, for example, aqueous caustic soda solution, or by a high-pressure water-jet station after the printing work is completed. There are several disadvantages for such a removal process: 1) dedicated cleaning and plumbing apparatus are required; 2) labor intensive process for multiple parts is involved; 3) incomplete removal of the support material may occur, especially within the cavities of the 3D-printed build sub-structure; 4) poor surface quality or loss of details may be obtained due to mechanical and/or chemical washing.

To overcome the problems above, it is highly desired to have a radiation-curable support sub-structure which is water-soluble so that it can be removed by a fast, easy and chemical-free removing process. At the same time, it is also highly desired to have a radiation-curable support sub-structure which has a high hardness at elevated temperatures to ensure good printing accuracy.

### SUMMARY OF THE INVENTION

It is an object of the invention to provide a radiation-curable composition to produce support material for 3D photopolymer jetting, wherein the support material can be fully water removable and also has a high hardness at elevated temperatures to ensure good printing accuracy.

Another object of the invention is to provide a 3D-printed object formed from the radiation-curable composition of the present invention as support material.

A further object of the present invention is to provide a process of forming 3D-printed object by using the radiation-curable composition of the present invention as support material.

It has been surprisingly found that the above objects can be achieved by following embodiments:
1. A radiation-curable composition comprising:
(A) at least one water-soluble monofunctional ethylenically unsaturated monomer;
(B) at least one water-soluble non-curable component, wherein the weighted average melting point of component (B) is more than 22° C., preferably more than 25° ° C.;
(C) at least one photoinitiator.
2. The radiation-curable composition according to item 1, wherein component (B) comprising at least one compound of formula (I)

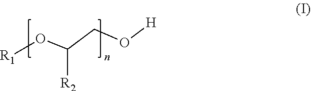

wherein R₁ is hydrogen or an alkyl group having not more than 6 carbon atoms, preferably not more than 3 carbon atoms; R₂ is hydrogen, alkyl, or alkoxy group, wherein alkyl or alkoxy group having not more than 6 carbon atoms, preferably not more than 3 carbon atoms.
3. The radiation-curable composition according to item 1 or 2, wherein component (B) is not reactive with component (A).
4. The radiation-curable composition according to any of items 1 to 3, wherein component (B) is polyethylene glycol, methoxypolyethylene glycol, polypropylene glycol or any combination thereof, preferably said component (B) is polyethylene glycol.
5. The radiation-curable composition according to any of items 1 to 4, wherein component (B) is not compatible with the photocured product of component (A).
6. The radiation-curable composition according to any of items 1 to 5, wherein weighted average melting point of component (B) is not more than 80° C., preferably not more than 70° C., more preferably not more than 60° C.
7. The radiation-curable composition according to any of items 1 to 6, wherein the amount of component (A) is in the range from 30 to 60 wt. %, preferably from 35 to 55 wt. %, more preferably from 40 to 50 wt. %, based on the total weight of the composition.
8. The radiation-curable composition according to any of items 1 to 7, wherein the amount of component (B) is in the range from 30 to 69 wt. %, preferably from 40 to 65 wt. %, more preferably from 50 to 60 wt. %, based on the total weight of the composition.
9. The radiation-curable composition according to any of items 1 to 8, wherein the amount of component (C) is in the range from 0.1 to 5 wt. %, preferably from 0.2 to 3 wt. %, based on the total weight of the composition.
10. The radiation-curable composition according to any of items 1 to 9, wherein the composition further comprises water as component (D) in an amount of 0 to 15 wt. %, preferably from 5 to 12 wt. %, based on the total weight of the composition.
11. The radiation-curable composition according to item 10, wherein weight ratio of component (D) to component (B) is in the range from 1:20 to 1:5.
12. The radiation-curable composition according to any of items 1 to 11, wherein the composition further comprises at least one inhibitor as component (E) in an amount of 0.1 to 2 wt. % or 0.2 to 1 wt. %, based on the total weight of the composition.
13. A photopolymer jetting 3D-printing process, comprising the steps of:
(i) drops of liquid photopolymers as build material and the composition of any of items 1 to 12 as support material are jetted onto a build platform through inkjet print heads separately to form a layer of pattern and the pattern was cured by UV radiation, infrared heat, microwave or a combination thereof;
(ii) the printing process of step (i) is repeated layer by layer to form a 3D-printed article of the build sub-structure supported by a 3D-printed support sub-structure;
(iii) the 3D-printed support sub-structure is removed using water.
14. The process according to item 13, wherein the temperature of water in step (iii) is at 30 to 90° C., preferably 40 to 70° C., more preferably 55 to 65° C.
15. The process according to item 13 or 14, wherein removal of 3D-printed support sub-structure is performed under ultrasonication, stirring, water jet and/or scrubbing.
16. A support sub-structure formed from the radiation-curable composition according to any of items 1 to 12.
17. A 3D-printed article formed with the support sub-structure according to item 16 or obtained by the process according to any of items 13 to 15.

The radiation-curable composition according to the present invention can be used as support sub-structure for 3D photopolymer jetting which can be fully water removable. On the other hand, the support sub-structure produced with the radiation-curable composition also has a high hardness at elevated temperature to ensure good printing accuracy.

### DESCRIPTION OF THE DRAWING

FIG. 1 shows the picture of dissolution time of support sub-structure obtained by printing the composition of example 13 as support material and the composition of example 14 as build material together.

FIG. 2 shows the 3D-printed object obtained by printing the composition of example 13 as support material and the composition of example 14 as build material together according to the standard benchmark model.

### EMBODIMENT OF THE INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a”, “an” and “the” refer to one or more of the species designated by the term following said article.

In the context of the present disclosure, any specific values mentioned for a feature (comprising the specific values mentioned in a range as the end point) can be recombined to form a new range.

As used herein, the term “radiation-curable” means initiation of cure of the composition may be accomplished by exposure to actinic light or radiation.

As used herein, the term “room temperature” refers generally to a temperature of 25±2° C.

The term “water-soluble” is defined as soluble in water in room temperature. In one embodiment, “water-soluble” means the water solubility of the component in room temperature can be more than 0.1 g/100 g, preferably more than 1 g/100 g, more preferably more than 5 g/100 g, more than 10 g/100 g, more than 20 g/100 g, most preferably more than 30 g/100 g, or more than 40 g/100 g, or more than 50 g/100 g.

### Radiation-Curable Composition

One aspect of the present invention is directed to a curable composition comprising:
(A) at least one water-soluble monofunctional ethylenically unsaturated monomer;
(B) at least one water-soluble non-curable component, wherein the weighted average melting point of component (B) is more than 22° C., preferably more than 25° ° C.;
(C) at least one photoinitiator.

### Component (A)

According to the invention, component (A) comprises at least one water-soluble monomer containing at least one monofunctional ethylenically unsaturated group. The term “monofunctional” in this context means it has only one polymerizable double bond in the chemical formula, preferably the polymerizable double bond is C═C double bond. Examples of component (A) include monofunctional monomers containing a vinyl, acryl, acrylate, methacrylate, vinylamide, or acrylamide group.

Examples of monofunctional acrylate include such as methyl acrylate, ethyl acrylate, butyl acrylate, 2-(2-ethoxy)ethyl acrylate, tetrahydrofurfuryl acrylate, lauryl acrylate, isooctyl acrylate, isodecyl acrylate, 2-phenoxyethylacrylate, 2-ethylhexyl acrylate, isobornyl acrylate, dicyclopentenyloxyethyl acrylate, dicyclopentadienyl acrylate, 2-hydroxyethyl acrylate, 2-hydroxypropyl acrylate, 2-hydroxybutyl acrylate, 4-hydroxybutyl acrylate, caprolactone acrylate, morpholine acrylate, epoxy-acrylate hybrid monomers such as 3,4-epoxy-cyclohexyl-14 methyl acrylate.

Examples of monofunctional methacrylate include such as isobornyl methacrylate, tetrahydrofurfuryl methacrylate, ethoxylated phenyl methacrylate, cyclohexylmethacrylate, lauryl methacrylate, stearyl methacrylate, octyl methacrylate, isodecyl methacrylate, tridecyl methacrylate, ca-prolactone methacrylate, nonyl phenol methacrylate, cyclic trimethylolpropane formal methacrylate, methoxy polyethyleneglycol methacrylates, methoxy polypropyleneglycol methacrylates, hydroxyethyl methacrylate, hydroxypropyl methacrylate and glycidyl methacrylate, epoxy-acrylate hybrid monomers such as 3,4-epoxy-cyclohexyl-14 methyl methacrylate.

Examples of monofunctional vinylamide component include such as N-vinyl-pyrrolidone, vinyl-imidazole, N-vinylcaprolactame, N-(hydroxymethyl)vinylamide, N-hydroxyethyl vinylamide, N-isopropylvinylamide, N-isopropylmethvinylamide, N-tert-butylvinylamide, N,N′-methylenebisvinylamide, N-(isobutoxymethyl)vinylamide, N-(butoxymethyl)vinylamide, N-[3-(dimethylamino)propyl]methvinylamide, N, N-dimethylvinylamide, N, N-diethylvinylamide and N-methyl-N-vinylacetamide.

Examples of monofunctional acrylamides or methacrylamides component include such as acryloylmorpholine (ACMO), methacryloylmorpholine, N-(hydroxymethyl)acrylamide, N-hydroxyethyl acrylamide, N-isopropylacrylamide, N-isopropylmethacrylamide, N-tert-butylacrylamide, N,N′-methylenebisacrylamide, N-(isobutoxymethyl)acrylamide, N-(butoxymethyl)acrylamide, N-[3-(dimethylamino)propyl]methacrylamide, N,N-dimethylacrylamide, N,N-diethylacrylamide, N-(hydroxymethyl)methacrylamide, N-hydroxyethyl methacrylamide, N-isopropylmethacrylamide, N-isopropylmethmethacrylamide, N-tert-butylmethacrylamide, N, N′-methylenebismethacrylamide, N-(isobutoxymethyl)methacrylamide, N-(butoxymethyl)methacrylamide, N-[3-(dimethylamino)propyl]methmethacrylamide, N,N-dimethylmethacrylamide and N, N-diethylmethacrylamide.

The amount of component (A) can be in the range from 30 to 60 wt. %, for example 35 wt. %, 40 wt. %, 45 wt. %, 50 wt. %, 55 wt. %, preferably from 35 to 55 wt. %, more preferably from 40 to 50 wt. %, based on the total weight of the radiation-curable composition.

### Component (B)

According to the present invention, component (B) is water-soluble and non-curable. The weighted average melting point of component (B) is more than 22° C., preferably more than 25° C., for example 23° C., 26° C., 28° C., 30° C., 35° C., 40° C., 45° C., 50° C., 60° C., 70° C. Preferably the weighted average melting point of component (B) is not more than 80° C., more preferably not more than 70° C., or more preferably not more than 60° C.

In one embodiment, component (B) is not reactive with component (A). In another embodiment, component (B) is not compatible with the photocured product of component (A).

In a preferred embodiment, component (B) comprises at least one compound of formula (I),

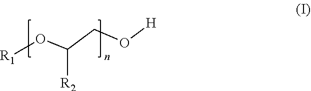

wherein R₁ is hydrogen or an alkyl group having not more than 6 carbon atoms; R₂ is hydrogen, alkyl, or alkoxy groups wherein alkyl or alkoxy groups having not more than 6 carbon atoms.

Preferably at least one of R₁ or R₂ in formula (I) are hydrogen.

Preferably the alkyl group of R₁ has not more than 3 carbon atoms. In a preferred embodiment, the alkyl group is a methyl group.

Preferably the alkyl or alkoxy group of R₂ has not more than 3 carbon atoms. In a preferred embodiment, the alkyl or alkoxy group is a C₁-C₃ alkyl group, or C₁-C₃ alkoxy group. In a most preferred embodiment, the alkyl or alkoxy group is a methyl or methoxy group.

As examples of compound of formula (I) may be mentioned, wherein R₁ and R₂ are hydrogen (polyethylene glycol (PEG)), or
R₁ is hydrogen, R₂ is C₁-C₃ alkyl group, in particular a methyl group (polypropylene glycol (PPG)), or
R₁ is C₁-C₃ alkyl group, in particular a methyl group, and R₂ is hydrogen (methoxypolyethylene glycol).

Particularly preferred component (B) are PEG and methoxypolyethylene glycol, most preferred is PEG.

In one embodiment, the molecular weight of component (B) can be in the range from 60 to 10000 g/mol, for example 100 g/mol, 150 g/mol, 200 g/mol, 400 g/mol, 600 g/mol, 1000 g/mol, 2000 g/mol, 4000 g/mol, 6000 g/mol, 8000 g/mol, preferably from 100 to 6000 g/mol, for example from 200 to 4000 g/mol.

The amount of component (B) can be in the range from 30 to 69 wt. %, for example 35 wt. %, 40 wt. %, 45 wt. %, 50 wt. %, 55 wt. %, 60 wt. %, 65 wt. %, preferably from 40 to 65 wt. %, more preferably from 50 to 60 wt. %, based on the total weight of the curable composition.

### Photoinitiator (C)

The radiation-curable composition comprises at least one photoinitiator as component (C). For example, the photoinitiator component (C) may include at least one free radical photoinitiator and/or at least one ionic photoinitiator, and preferably at least one (for example one or two) free radical photoinitiator. For example, it is possible to use all photoinitiators known in the art for use in compositions for 3D-printing, e.g., it is possible to use photoinitiators that are known in the art use with SLA, DLP or PPJ (Photo polymer jetting) processes.

Exemplary photoinitiators may include benzophenone, acetophenone, chlorinated acetophenone, dialkoxyacetophenones, dialkylhydroxyacetophenones, dialkylhydroxyacetophenone esters, benzoin and derivative (such as benzoin acetate, benzoin alkyl ethers), dimethoxybenzion, dibenzylketone, benzoylcyclohexanol and other aromatic ketones, alpha-aminoketone compounds, phenylglyoxylate compounds, oxime ester, acyloxime esters, acylphosphine oxides, acylphosphonates, ketosulfides, dibenzoyldisulphides, diphenyldithiocarbonate, mixtures thereof and mixtures with alpha-hydroxy ketone compounds, or alpha-alkoxyketone compounds.

For example, the free radical photoinitiator may be chosen from those commonly used to initiate radical photopolymerization. Examples of free radical photoinitiators include Irgacure® 369, Irgacure® TPO-L, benzoins, e.g., benzoin, benzoin ethers such as benzoin methyl ether, benzoin ethyl ether, benzoin isopropyl ether, benzoin phenyl ether, and benzoin acetate; acetophenones, e.g., acetophenone, 2,2-dimethoxyacetophenone, 2,2-dimethoxy-2-phenylacetophenone and 1,1-dichloroacetophenone; benzyl ketals, e.g., benzyl dimethylketal and benzyl diethyl ketal; anthraquinones, e.g., 2-methylanthraquinone, 2-ethylanthraquinone, 2-tertbutylanthraquinone, 1-chloroanthraquinone and 2-amylanthraquinone; triphenylphosphine; benzoylphosphine oxides, e.g., 2,4,6-trimethylbenzoy-diphenylphosphine oxide (Lucirin TPO); ethyl-2,4,6-trimethylbenzoylphenylphosphinate; bisacylphosphine oxides; benzophenones, e.g., benzophenone and 4,4′-bis(N,N′-dimethylamino)benzophenone; thioxanthones and xanthones; acridine derivatives; phenazine derivatives; quinoxaline derivatives; 1-phenyl-1,2-propanedione 2-O-benzoyl oxime; 4-(2-hydroxyethoxy)phenyl-(2-propyl)ketone (Irgacure® 2959); 2-methyl-1-[4-(methylthio)phenyl]-2-(4-morpholinyl)-1-propanone; 1-aminophenyl ketones or 1-hydroxy phenyl ketones, e.g., 1-hydroxycyclohexyl phenyl ketone, 2-hydroxyisopropyl phenyl ketone, phenyl 1-hydroxyisopropyl ketone, and 4-isopropylphenyl 1-hydroxyisopropyl ketone, and combinations thereof.

Specific examples of photoinitiators can include 1-hydroxycyclohexyl phenylketone, 2-methyl-1-[4-(methylthio)phenyl]-2-morpholinopropan-1-one, 2-benzyl-2-N,N-dimethylamino-1-(4-morpholinophenyl)-1-butanone, combination of 1-hydroxycyclohexyl phenyl ketone and benzophenone, 2,2-dimethoxy-2-phenyl acetophenone, bis(2,6-dimethoxybenzoy 1-(2,4,4-trimethylpentyl)phosphine oxide, 2-hydroxy-2-methyl-1-phenyl-propan-1-one, bis(2,4,6-trimethyl benzoyl) phenyl phosphine oxide, 2-hydroxy-2-methyl-1-phenyl-1-propane, 2,4,6-trimethylbenzoyldiphenyl-phosphine oxide, 2-hydroxy-2-methyl-1-phenyl-propan-1-one, 2,4,6-trimethylbenzoyldiphenylphosphinate and 2,4,6-trimethylbenzoyldiphenyl-phosphine oxide and also any combination thereof.

The amount of the photoinitiator (C) can be in the range from 0.1 to 5 wt. %, for example 0.2 wt. %, 0.5 wt. %, 0.8 wt. %, 1 wt. %, 2 wt. %, 3 wt. %, 4 wt. %, or 5 wt. %, preferably from 0.1 to 4 wt. % or 0.2 to 3 wt. %, based on the total weight of the composition.

In one embodiment, the radiation-curable composition of the present invention comprising following components:
(A) at least one water-soluble monofunctional ethylenically unsaturated monomer;
(B) at least one water-soluble non-curable component, wherein the weighted average melting point of component (B) is more than 22° C., preferably more than 25° C.;
(C) at least one photoinitiator,
the amount of component (A) can be represented from 30 to 60 wt. % or 35 to 55 wt. % or 40 to 50 wt. %; the amount of component (B) can be represented from 30 to 69 wt. % or 40 to 65 wt. % or 50 to 60 wt. %; the amount of component (C) can be represented from 0.1 to 5 wt. % or 0.1 to 4 wt. % or 0.2 to 3 wt. %.

### Water (D)

The composition of the present invention may further comprise water. There is no special requirement of the water. The amount of water can be in the range from 0 to 15 wt. %, for example 1 wt. %, 2 wt. %, 3 wt. %, 4 wt. %, 5 wt. %, 6 wt. %, 7 wt. %, 8% wt. %, 9 wt. %, 10 wt. %, 11 wt. %, 12 wt. %, 13 wt. % or 14 wt. %, preferably from 5 to 12 wt. %, based on the total weight of the composition. In a preferred embodiment, the weight ratio of water to component (B) is in the range from 1:20 to 1:5.

### Inhibitor (E)

The composition of the present invention may further comprise at least one polymerization inhibitor. Examples of the polymerization inhibitor can be phenolic based inhibitors such as hydroquinone (HQ), 4-methoxyphenol (MEHQ), butylhydroxytoluene (BHT), hydroquinone monomethyl ether, 2,6-di-tert-butyl-p-cresol, 2,2-methylene-bis-(4-methyl-6-tert-butylphenol), and 1,1,3-tris-(2-methyl-4-hydroxy-5-tert-butylphenyl) butane, amine compounds such as phenothiazine, nitrosophenylhydroxylamine (NPHA) and its salts, aromatic amine stabilizers such as diphenylamine (DPA) and phenylenediamine (PPD), metal deactivators such as benzotriazole, Alkoxylamine (NOR) HALS stabilizers such as derivatives of 2,2,6,6-tetramethyl piperidine, Nitroxyl stabilizers, including mixtures or combinations thereof.

The amount of the polymerization inhibitor can be less than 2 wt. %, for example 0.1 wt. %, 0.2 wt. %, 0.5 wt. %, 1 wt. %, or 2 wt. %, preferably from 0.2 to 1 wt. %, based on the total amount of the composition.

### Auxiliaries (F)

The composition of the present invention may further comprise one or more auxiliaries.

As auxiliaries, mention may be made by way of preferred example of surface-active substances, flame retardants, nucleating agents, lubricant wax, dyes, pigments, catalyst, UV absorbers and stabilizers, e.g. against oxidation, hydrolysis, light, heat or discoloration, inorganic and/or organic fillers, reinforcing materials and plasticizers. As hydrolysis inhibitors, preference is given to oligomeric and/or polymeric aliphatic or aromatic carbodiimides. To stabilize the material cured of the invention against aging and damaging environmental influences, stabilizers are added to system in preferred embodiments.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliaries may be found in the specialist literature, e.g. in Plastics Additive Handbook, 5th edition, H. Zweifel, ed, Hanser Publishers, Munich, 2001.

According to the present invention, the auxiliary can be present in an amount of from 0 to 50 wt. % by weight, from 0.01 to 50 wt. % by weight, for example from 0.5 to 30 wt. % by weight, based on the total weight of the curable composition.

### Preparation of the Composition

A further aspect of this disclosure relates to a process of preparing the radiation-curable composition of the present invention, comprising mixing the components of the composition. According to an embodiment of the invention, the mixing can be carried out at room temperature or preferably at an elevated temperature (for example from 30 to 90° C., preferably from 35 to 80° C.) with stirring. There is no particular restriction on the time of mixing and rate of stirring, as long as all components are uniformly mixed together. In a specific embodiment, the mixing can be carried out at 1000 to 3000 RPM, preferably 1500 to 2500 RPM for 5 to 60 min, more preferably 6 to 30 min.

### 3D-Printed Support Sub-Structure, Preparation and Removal Thereof

One aspect of the present disclosure relates to a process of forming 3D-printed support sub-structure, comprising using the curable composition of the present invention as support material. The radiation-curable liquid composition can be cured by actinic ray that has sufficient energy to initiate a polymerization or cross-linking reaction. The actinic ray can include but is not limited to α-rays, γ-rays, ultraviolet radiation (UV radiation), visible light, and electron beams, wherein UV radiation and electron beams, especially, UV radiation is preferred.

In a specific embodiment, the wavelength of the radiation light can be in the range from 350 to 420 nm, for example 355, 365, 385, 395, 405, 420 nm. The energy of radiation can be in the range from 0.5 to 2000 mw/cm², for example 1 mw/cm², 2 mw/cm², 3 mw/cm², 4 mw/cm², 5 mw/cm², 8 mw/cm², 10 mw/cm², 20 mw/cm², 30 mw/cm², 40 mw/cm², or 50 mw/cm², 100 mw/cm², 200 mw/cm², 400 mw/cm², 500 mw/cm², 1000 mw/cm², 1500 mw/cm² or 2000 mw/cm². The radiation time can be in the range from 0.5 to 10 s, preferably from 0.6 to 6 s.

The photopolymer jetting 3D-printed support sub-structure is produced by jetting drops of said liquid 3D-printing support material composition onto a build platform through one or more inkjet 3D-printer heads, followed by immediate UV light irradiation. The 3D-printing support material composition is preferably used as ink for the printer head directly. This process is repeated layer-by-layer to form a 3D-printed support sub-structure. The build material composition is jetted onto the build platform simultaneously, forming a 3D-printed build sub-structure, which forms a 3D-printed composite structure with the 3D-printed support sub-structure supports the 3D-printed build sub-structure.

The device used is well known to those skilled in the art, and can be exemplified by Eden 250, Eden 260V, Eden 500V, CONNEX 500 available from Stratasys, Eden Prairie, MN, USA, or MJP 2500 Series available from 3D systems, Rock Hill, SC, USA, or Agilista 3100 from Keyence, Osaka, Japan.

The build material composition that is jetted onto the build platform together with the 3D-printing support material composition (but in different drops) is well known to those skilled in the art. For example, the composition can be exemplified by EPJ1300, EPJ2100, EPJ2200, etc. available from BASF SE. For example, the composition can also be exemplified by RGD720, RGD525 etc. available from Stratasys, Eden Prairie, MN, USA. Although other known build materials may be used combinedly with the as mentioned support compositions, it is preferred to use the abovementioned build materials for optimized compatibility.

After the completion of the printing of the build material through the inkjet print heads, and subsequent UV light irradiation, the 3D-printed support sub-structure can be removed using water. Particularly, the removing time of the 3D-printed support sub-structure can be decreased by using warm water at a specified temperature, such as 30 to 90° C., preferably 40 to 70° ° C., more preferably about 60° C., with or without ultrasonication, stirring, water jet and/or scrubbing.

In order to simplify the measurement of the time, it is possible to use a piece of bulk polymerized 3D-printing support material rather than a 3D-printed support sub-structure. To do so, the 3D-printing support material composition of the present invention is prepared and polymerized in absence of any 3D-printing build material under the same condition to prepare the 3D-printed composite structure comprising the 3D-printed build sub-structure and the 3D-printed support sub-structure. The obtained bulk polymerized 3D-printing support material is put into water under the same condition to remove the 3D-printed support sub-structure from the 3D-printed composite structure, and the time before complete dissolution of the bulk polymerized 3D-printing support material is measured. Those skilled in the art will appreciate that although the time period used to completely dissolve the bulk polymerized 3D-printing support material can be different from the time period to completely dissolve the 3D-printed support sub-structure, the above two time periods are closely related proportionally.

The 3D-printed support sub-structure of the present invention can have the Asker C hardness at 60° C. of more than 70, preferably more than 80, more preferably more than 90, for example 75, 85, 90, 95, and the dissolution time at 60° C. of less than 950 s, preferably less than 600 s, more preferably less than 400 s, for example 945s, 900 s, 800 s, 700 s, 600 s, 500 s, 400 s, 300 s, 200 s, which ensure the good printing accuracy and fast full water removability.

### EXAMPLES

The present invention is further illustrated by the following examples, which are set forth to illustrate the present invention and is not to be construed as limiting thereof. Unless otherwise noted, all parts and percentages are by weight.

### Materials and Abbreviation

ACMO: Acryloylmorpholine, which is available from RAHN, viscosity is 12-14 mPa·s at 25° C.
PEG 600: Polyethylene glycol 600, molecular weight 600 g/mol, melting point 20° C.;
PEG 1000: Polyethylene glycol 1000, molecular weight 1000 g/mol, melting point 37° C.;
PEG 2000: Polyethylene glycol 2000, molecular weight 2000 g/mol, melting point 51° ° C.;
TPO-L: 2,4,6-trimethylbenzoyldiphenylphosphine oxide from Omnicure.
MEHQ: 4-methoxyphenol, which is available from Sinoreagent.
Laromer UA9089: polymeric urethane acrylate, viscosity is 18-24 Pas at 23° C. Isobornyl acrylate (IBOA).

### Test Method

(1) Weighted Average Melting Point:

$$Weighted average melting point = \frac{{\sum }_{i = 1}^{n} {w}_{i} {M}_{i}}{{\sum }_{i = 1}^{n} {w}_{i}}$$

where Mᵢ and wᵢ are the melting point and amount of an individual ingredient in component B, respectively; n is number of ingredients in component B.
(2) Dissolution time: the time required to fully dissolve a printed sample (dimension 1 cm×1 cm×1 cm, ˜1 gram) in 60° C. water agitated with ultra-sonification.
(3) Asker C Hardness: measured with an Asker C hardness tester on sample surface in accordance with ASTM D2240.

### Examples 1 to 8

The curable compositions in examples 1 to 8 were prepared by adding all components in amounts as shown in table 1 into a plastic vial and mixing by FlackTek DAC 600.1 VAC-P speed-mixer at 2000 RPM for 10 minutes at 50° C. to ensure all solids were dissolved, followed by filtration with filter papers/capsule filters with 1 μm pore size to obtain the liquid curable compositions.

A Notion PPJ 3D printer equipped with 2 Xaar 1003GS12 printheads was used for examples 1 to 8 printing. Specimens were directly prepared by 3D printing with 20% UV energy (around 400 mW/cm²) and 250 mm/s printing speed, followed by 20 minutes UV post-cure using NextDent UV curing box.

The dissolution time and hardness at different temperature of the cured samples obtained from compositions of examples 1 to 8 via 3D-printing were also shown in table 1.

TABLE 1

| Examples | 1 | 2 | 3 | 4 | 5 | 6 | 7 | 8 |
|---|---|---|---|---|---|---|---|---|
| ACMO | 40 | 45 | 45 | 47 | 45 | 50 | 40 | 50 |
| PEG600 | 40 | 30 | 30 | 40 | 30 | 0 | 0 | 0 |
| PEG1000 | 20 | 25 | 23 | 11 | 20 | 31 | 54 | 7 |
| PEG2000 | 0 | 0 | 0 | 0 | 0 | 14 | 0 | 33 |
| H₂O | 0 | 0 | 2 | 2 | 5 | 5 | 6 | 10 |
| TPO-L | 1 | 1 | 1 | 1 | 1 | 1 | 1 | 1 |
| Sum | 101 | 101 | 101 | 101 | 101 | 101 | 101 | 101 |
| Weighted | 25.7 | 27.7 | 27.4 | 23.7 | 26.8 | 44.8 | 37 | 57.6 |
| average | | | | | | | | |
| melting point | | | | | | | | |
| Dissolution | 270 | 321 | 381 | 422 | 502 | 945 | 608 | 945 |
| time (s) | | | | | | | | |
| Hardness | 75 | 85 | 90 | 70 | 90 | 95 | 85 | 85 |
| Asker C @ | | | | | | | | |
| 60° C. | | | | | | | | |

### Comparative Examples 1 and 2

The compositions in comparative examples 1 and 2 were prepared by adding all components in amounts as shown in table 2 into a plastic vial and mixing by FlackTek DAC 600.1 VAC-P speed-mixer at 2000 RPM for 10 minutes at 50° C. to ensure all solids were dissolved, followed by filtration with filter papers/capsule filters with 1 μm pore size to obtain the liquid curable compositions.

The 3D-printing method was same as 3D-printing method described in examples 1 to 8.

TABLE 2

| | Examples | |
|---|---|---|
| | Comparative | Comparative |
| | example 1 | example 2 |
| ACMO | 40 | 40 |
| PEG600 | 60 | 40 |
| PEG1000 | 0 | 0 |
| PEG2000 | 0 | 0 |
| H₂O | 0 | 20 |
| TPO-L | 1 | 1 |
| Sum | 101 | 101 |
| Weighted average | 20 | 20 |
| melting point | | |
| Results | Gel-like | Not cured |
| | after cured | by UV |

As could be seen, after UV radiation, the compositions result in gel-like material or not curable at all, which cannot be used as support material for photopolymer jetting.

### Examples 9 to 12

The composition in examples 9 to 12 were prepared by adding all components in amounts as shown in table 3 into a plastic vial and mixing by FlackTek DAC 600.1 VAC-P speed-mixer at 2000 RPM for 10 minutes to obtain the homogeneous liquid curable compositions. Then the compositions were placed in 4° C. refrigerator for 24 hours to observe their freezing behaviors.

TABLE 3

| | Examples | | | | |
|---|---|---|---|---|---|
| | 1 | 9 | 10 | 11 | 12 |
| ACMO | 40 | 40 | 40 | 50 | 50 |
| PEG600 | 40 | 18 | 30.7 | 15 | 25.5 |
| PEG1000 | 20 | 30 | 23.3 | 25 | 19.5 |
| H₂O | 0 | 12 | 6 | 10 | 5 |
| TPO-L | 1 | 1 | 1 | 1 | 1 |
| Weighted average | 25.7 | 30.6 | 27.3 | 30.6 | 27.4 |
| melting point | | | | | |
| Freeze at 4° C. | YES | NO | NO | NO | NO |

### Example 13

The composition in example 13 was prepared by adding all components in amounts as shown in table 1 into a plastic vial and mixing by FlackTek DAC 600.1 VAC-P speed-mixer at 2000 RPM for 10 minutes at 50° ° C. to ensure all solids were dissolved, followed by filtration with filter papers/capsule filters with 1 μm pore size to obtain the liquid curable compositions. The 3D-printing method was the same as 3D-printing method described in examples 1 to 8.

TABLE 4

| | Examples | | |
|---|---|---|---|
| | 2 | 5 | 13 |
| ACMO | 45 | 45 | 45 |
| PEG600 | 30 | 30 | 30 |
| PEG1000 | 25 | 20 | 20 |
| H₂O | 0 | 5 | 5 |
| TPO-L | 1 | 1 | 1 |
| MEHQ | 0 | 0 | 0.5 |
| Sum | 101 | 101 | 101.5 |
| Weighted average | 27.7 | 26.8 | 26.8 |
| melting point | | | |
| Stability @ 60° C. | >4 weeks | >4 weeks | >4 weeks |
| Stability @ 60° C. with | >4 weeks | 1 day | >2 weeks |
| presence of metals | | | |
| Hardness Asker | 85 | 90 | 86 |
| C @ 60° C. | | | |

As could be seen, presence of water within the composition would cause stability issue when contacted with transitional metals, such as copper, nickel, stainless steel. However, addition of polymerization inhibitor (MEHQ is chosen in example 13) can solve this issue without making obvious influences on the material performances.

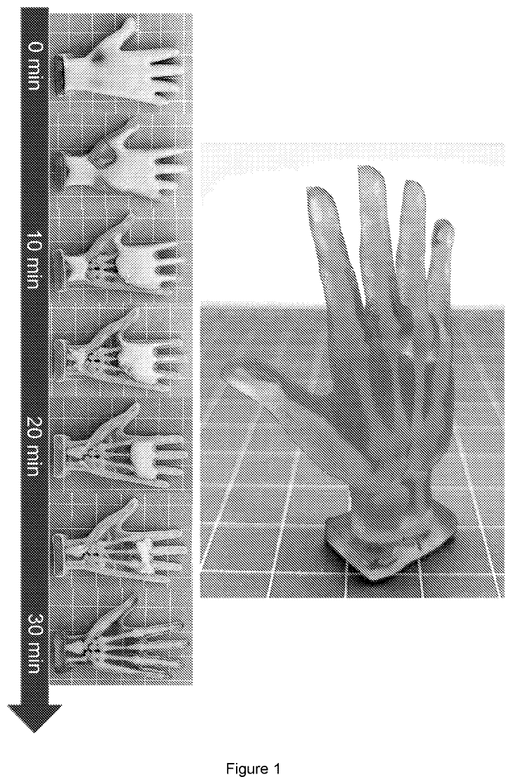

FIG. 1 illustrating dissolution time of support sub-structure obtained by printing the composition of example 13 as support material and the composition of example 14 as build material. A Notion PPJ 3D printer equipped with 2 Xaar 1003GS12 printheads was used for sample printing. The as-mentioned 3D object was directly prepared by 3D printing with 20% UV energy (around 400 mW/cm²) and 250 mm/s printing speed, during which the support material and build material were dispensed from the printheads in the form of single droplets onto designated locations of the substrate to form a 2D pattern. By repeating this process layer by layer, the 3D object was printed.

The support sub-structure was removed from the build sub-structure by soaking the printed part into 60° C. water and agitated with ultrasonification for 30 minutes. Water was replaced when the concentration of dissolved support material reached 2%.

TABLE 5

| | Example |
|---|---|
| | 14 |
| Laromer UA9089 | 25 |
| Acryloylmorpholine (ACMO) | 25 |
| Isobornyl acrylate (IBOA) | 50 |
| TPO-L | 2 |
| Sum | 102 |

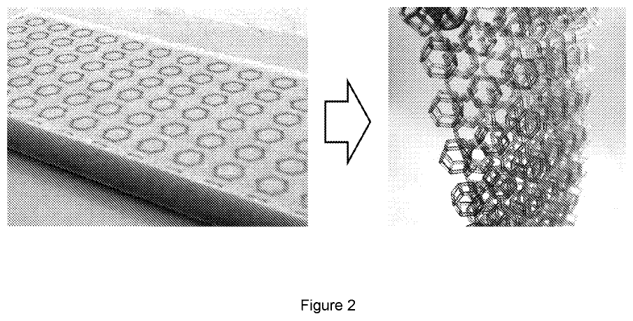

The picture of 3D-printed object obtained by printing the composition of example 13 as support material and the composition of example 14 as build material together according to the standard benchmark model was shown in FIG. 2. The 3D-printing method is the same as the method described in FIG. 1. It demonstrated that good printing accuracy during a long printing process could be achieved and delicate structures were fabricated by the curable composition of the present invention as support material.

1.-17. (canceled)

18. A radiation-curable composition comprising:
(A) at least one water-soluble monofunctional ethylenically unsaturated monomer;
(B) at least one water-soluble non-curable component, wherein the weighted average melting point of component (B) is more than 22° C., preferably more than 25° C.;
(C) at least one photoinitiator.

19. The radiation-curable composition according to claim 18, wherein component (B) comprising at least one compound of formula (I) 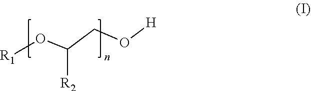
wherein R₁ is hydrogen or an alkyl group having not more than 6 carbon atoms, preferably not more than 3 carbon atoms; R₂ is hydrogen, alkyl, or alkoxy group, wherein alkyl or alkoxy group having not more than 6 carbon atoms, preferably not more than 3 carbon atoms.

20. The radiation-curable composition according to claim 18, wherein component (B) is not reactive with component (A).

21. The radiation-curable composition according to claim 18, wherein component (B) is polyethylene glycol, methoxypolyethylene glycol, polypropylene glycol or any combination thereof.

22. The radiation-curable composition according to claim 18, wherein component (B) is not compatible with the photocured product of component (A).

23. The radiation-curable composition according to claim 18, wherein weighted average melting point of component (B) is not more than 80° C.

24. The radiation-curable composition according to claim 18, wherein the amount of component (A) is in the range from 30 to 60 wt. %, based on the total weight of the composition.

25. The radiation-curable composition according to claim 18, wherein the amount of component (B) is in the range from 30 to 69 wt. %, based on the total weight of the composition.

26. The radiation-curable composition according to claim 18, wherein the amount of component (C) is in the range from 0.1 to 5 wt. %, based on the total weight of the composition.

27. The radiation-curable composition according to claim 18, wherein the composition further comprises water as component (D) in an amount of 0 to 15 wt. %, based on the total weight of the composition.

28. The radiation-curable composition according to claim 27, wherein weight ratio of component (D) to component (B) is in the range from 1:20 to 1:5.

29. The radiation-curable composition according to claim 18, wherein the composition further comprises at least one inhibitor as component (E) in an amount of 0.1 to 2 wt. % or 0.2 to 1 wt. %, based on the total weight of the composition.

30. A photopolymer jetting 3D-printing process, comprising the steps of:
(i) drops of liquid photopolymers as build material and the composition of claim 18 as support material are jetted onto a build platform through inkjet print heads separately to form a layer of pattern and the pattern was cured by UV radiation, infrared heat, microwave or a combination thereof;
(ii) the printing process of step (i) is repeated layer by layer to form a 3D-printed article of the build sub-structure supported by a 3D-printed support sub-structure;
(iii) the 3D-printed support sub-structure was removed using water.

31. The process according to claim 30, wherein the temperature of water in step (iii) is at 30 to 90° C.

32. The process according to claim 30, wherein removal of 3D-printed support sub-structure is performed under ultrasonication, stirring, water jet and/or scrubbing.

33. A support sub-structure formed from the radiation-curable composition according to claim 18.

34. A 3D-printed article formed with the support sub-structure according to claim 33.
